(19) United States
(12) Patent Application Publication
(10) Pub. No.: US 2007/0208156 A1
(43) Pub. Date: Sep. 6, 2007

(54) Polyurea polymers with improved flexibility using secondary polyetheramines

(75) Inventors: Mark L. Posey, Spring, TX (US); Kenneth M. Hillman, Spring, TX (US)

Correspondence Address: Legal Department;Huntsman Corporation, 10003 Woodloch Forest Drive, The Woodlands, TX, 77380, US

(73) Assignee: Huntsman Petrochemical Corporation, The Woodlands, TX (US)

(21) Appl. No.: 11/365,725

(22) Filed: Mar. 1, 2006

(51) Int. Cl. C08G 18/00

(52) U.S. Cl. 528/44

(57) ABSTRACT

Provided herein are polymers, including polyureas, polyurethanes, and polyurea-polyurethane hybrids, made from an isocyanate, a secondary polyetheramine, a second amine, and optionally a polyol. The secondary polyetheramine may be used in combination with the second amine to modify other properties of the polymer, including its cure time and cost.

### FIELD OF THE INVENTION

The present invention relates generally to polymers. More specifically, it relates to the preparation of polymeric reaction products formed from the reaction between an isocyanate, a secondary polyetheramine, a second amine and optionally a polyol and aspartic ester amine.

### BACKGROUND INFORMATION

Polymers can be formed from the reaction of one or more isocyanates with one or more amines. These polymers can be formed by bringing the isocyanates in contact with the amines using static mixing equipment, high-pressure impingement mixing equipment, low-pressure mixing equipment, roller with mixing attachments and simple hand mixing techniques. These polymers are useful in caulks, adhesives, sealants, coatings, foams, and many other applications. Specific examples include, but are not limited to, truck-bed liners, concrete coatings, and molded articles.

Multiple amines that are used to form these polymers have disadvantages. Some of these disadvantages include amines that form brittle end-product polymers and amines that significantly contribute to the cost of the polymer. One major disadvantage is amines with unsatisfactory cure times for specific applications. For example, many amines cannot be used for polymer spray systems because of fast cure times. Therefore, these amines cannot be used to form spray coatings or spray moldings, thereby reducing their potential applications. Many approaches have tried to overcome these disadvantages with limited success.

### SUMMARY OF THE INVENTION

Embodiments of the present invention disclose a process for forming a polymer by providing a first component having at least one isocyanate and a second component having at least one secondary polyetheramine and at least one second amine. The first component and the second component are contacted so as to form the polymer. Other embodiments disclose a process that further has at least one polyol in the first or second component, or in both.

Another embodiment further discloses a polymer made by the process of providing a first component having at least one isocyanate and a second component having at least one secondary polyetheramine and at least one second amine. The first component and the second component are then contacted so as to form the polymer. In one embodiment, the contacting is performed by using a spray polymer system.

By using secondary polyetheramines, the brittleness of the polymers may be controlled, the cure time may be modified, the viscosity of the amine blend may be reduced and other properties may be modified. By replacing part of the second amines with secondary polyetheramines, the cost of the final polymer may also be reduced.

### DETAILED DESCRIPTION

According to the present invention, secondary polyetheramines are employed in the production of polymers. In this disclosure, a polymer shall include, but not be limited to, polyureas, polyurethanes, and polyurea-polyurethane hybrids. One skilled in the art will recognize other polymer applications for teachings of this invention.

Embodiments of the present invention include a polymer produced by using a first component having at least one isocyanate and a second component having at least one secondary polyetheramine and at least one second amine.

The first component has at least one isocyanate. As used in the present specification and the appended claims, the term “isocyanate” includes a wide variety of materials recognized by those skilled in the art as being useful in preparing polyurea and polyurethane polymer materials. Included within this definition are both aliphatic and aromatic isocyanates, as well as one or more prepolymers or quasi-prepolymers prepared using such isocyanates as a starting material, as is generally well known in the art. Preferred examples of aliphatic isocyanates are of the type described in U.S. Pat. No. 4,748,192, as well as aliphatic di-isocyanates and, more particularly, the trimerized or the biuretic form of an aliphatic di-isocyanate, such as hexamethylene di-isocyanate (“HDI”), and the bi-functional monomer of the tetraalkyl xylene di-isocyanate, such as the tetramethyl xylene di-isocyanate. Cyclohexane di-isocyanate is also to be considered a useful aliphatic isocyanate. Other useful aliphatic polyisocyanates are described in U.S. Pat. No. 4,705,814. They include aliphatic di-isocyanates, for example, alkylene di-isocyanates with 4 to 12 carbon atoms in the alkylene radical, such as 1,12-dodecane di-isocyanate, 1,4-tetramethylene di-isocyanate, and 1,6-hexamethylene di-isocyanate. Also useful are cycloaliphatic di-isocyanates, such as 1,3 and 1,4-cyclohexane di-isocyanate as well as any mixture of these isomers, 1-isocyanato-3,3,5-trimethyl-5-isocyanatomethylcyclohexane (isophorone di-isocyanate); 4,4′-,2,2′- and 2,4′-dicyclohexylmethane di-isocyanate, H₁₂ MDI (methylene bisphenyl isocyanate), hydrogenated MDI as well as the corresponding isomer mixtures, and the like.

A wide variety of aromatic polyisocyanates may also be used to form a polymer according to the present invention, and typical aromatic polyisocyanates include p-phenylene di-isocyanate, polymethylene polyphenylisocyanate, 2,6-toluene di-isocyanate, dianisidine di-isocyanate, 2,4-toluene di-isocyanate, dianisidine di-isocyanate, bitolylene di-isocyanate, naphthalene-1,4-di-isocyanate, bis(4-isocyanatophenyl)methane, bis(3-methyl-3-iso-cyanatophenyl)methane, bis(3-methyl-4-isocyanatophenyl)methane, and 4,4′-diphenylpropane di-isocyanate, as well as MDI-based quasi-prepolymers, including without limitation 2,4 methylene bisphenyl isocyanate and 4,4′ methylene bisphenyl isocyanate, such as those available commercially as RUBINATE® 9480 MDI, RUBINATE® 9484 MDI, and RUBINATE® 9495 MDI from Huntsman International, LLC.

Other aromatic polyisocyanates used in the practice of the invention are methylene-bridged polyphenyl polyisocyanate mixtures which have a functionality of from about 2 to about 4. These latter isocyanate compounds are generally produced by the phosgenation of corresponding methylene bridged polyphenyl polyamines, which are conventionally produced by the reaction of formaldehyde and primary aromatic amines, such as aniline, in the presence of hydrochloric acid and/or other acidic catalysts. Known processes for preparing polyamines and corresponding methylene-bridged polyphenyl polyisocyanates therefrom are described in the literature and in many patents, for example, U.S. Pat. Nos. 2,683,730; 2,950,263; 3,012,008; 3,344,162 and 3,362,979. Usually methylene-bridged polyphenyl polyisocyanate mixtures contain about 20 to about 100 weight percent methylene di-phenyl-di-isocyanate isomers, with the remainder being polymethylene polyphenyl di-isocyanates having higher functionalities and higher molecular weights. Typical of these are polyphenyl polyisocyanate mixtures containing about 20 to about 100 weight percent di-phenyl-di-isocyanate isomers, of which about 20 to about 95 weight percent thereof is the 4,4′-isomer with the remainder being polymethylene polyphenyl polyisocyanates of higher molecular weight and functionality that have an average functionality of from about 2.1 to about 3.5. These isocyanate mixtures are known, commercially available materials and can be prepared by the process described in U.S. Pat. No. 3,362,979. The present invention includes the use of mixtures of isomers of isocyanates, which are produced simultaneously in a phosgenation reaction, or any blend of two or more isocyanates (including two or more mixtures of isocyanates, or a single isocyanate with a mixture of isocyanates) which are produced using two or more separate phosgenations. One preferred aromatic polyisocyanate is methylene bis(4-phenylisocyanate) or “MDI”. Pure MDI, quasi-prepolymers of MDI, modified pure MDI, etc. are useful to prepare materials according to the invention. Since pure MDI is a solid and, thus, often inconvenient to use, liquid products based on MDI or methylene bis(4-phenylisocyanate) are also useful herein. U.S. Pat. No. 3,394,164 describes a liquid MDI product. More generally, uretonimine modified pure MDI is included also. This product is made by heating pure distilled MDI in the presence of a catalyst. The liquid product is a mixture of pure MDI and modified MDI. The term isocyanate also includes quasi-prepolymers of isocyanates or polyisocyanates with active hydrogen containing materials. Any of the isocyanates mentioned above may be used as the isocyanate component in the present invention, either alone or in combination with other aforementioned isocyanates. One skilled in the art with the benefit of this disclosure will recognize suitable isocyanates to use for a particular application.

The second component has at least one secondary polyetheramine and at least one second amine. The secondary polyetheramines may be obtained by reacting primary polyetheramines with a di-alkyl ketone, aldehyde, or cyclic ketone or other carbonyl-function containing molecule in the presence of hydrogen and a catalyst. The secondary polyetheramines so obtained are typically light in color, have low viscosities, and remain liquid at room temperature, which is a marked advantage which will be greatly appreciated by industrial producers of polymers.

The term “secondary polyetheramines” when used in this specification and the claims appended hereto means those secondary amines within the definitions of formula: 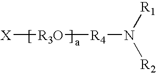
in which R₁ and R₂ are each independently selected from the group consisting of: hydrogen; an alkyl group having 1, 2, 3, 4, 5, 6, 7, 8, 9, or 10 carbon atoms, whether straight-chain or branched; or cyclic; or a radical of the formula: 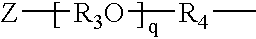
in which R₃ in each occurrence may be an alkyl group having any number of carbon atoms selected from 1, 2, 3, 4, 5, or 6, straight-chain or branched; R₄ in each occurrence is a straight-chain or branched alkyl bridging group having 1, 2, 3, 4, 5, or 6 carbon atoms; Z is a hydroxy group or alkyl group containing 1, 2, 3, 4, 5, or 6 carbon atoms, straight-chain or branched; q is any integer between 0 and 400; and wherein X is any of:
i) a hydroxy group or an alkyl group having any number of carbon atoms selected from 1, 2, 3, 4, 5, or 6; or
ii) a group 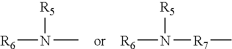
in which R₅ and R₆ are each independently selected from the group consisting of: hydrogen; an alkyl group having 1, 2, 3, 4, 5, 6, 7, 8, 9, or 10 carbon atoms, whether straight-chain or branched; or cyclic; or 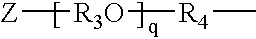
as defined above in which Z is a hydroxy group or an alkoxy group having 1, 2, 3, 4, 5, or 6 carbon atoms, and in which R₇ is a straight-chain or branched alkylene bridging group having 1, 2, 3, 4, 5, or 6 carbon atoms; or
iii) a moiety of the formula: 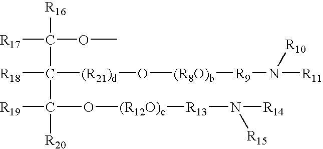
in which R₁₀, R₁₁, R₁₄, and R₁₅ are each independently selected from the group of: hydrogen; an alkyl group having 1, 2, 3, 4, 5, 6, 7, 8, 9, or 10 carbon atoms, straight-chain or branched; or cyclic; the moiety

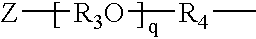

as defined above in which Z is a hydroxy or alkoxy group having 1, 2, 3, 4, 5, or 6 carbon atoms; R₉ and R₁₂ are each independently alkyl groups having 1, 2, 3, 4, 5, or 6 carbon atoms, straight-chain or branched; R₉, R₁₃, and R₂₁ are each independently selected from a straight-chain or branched alkyl bridging linkage having 1, 2, 3, 4, 5, or 6 carbon atoms; R₁₆, R₁₇, R₁₈, R₁₉, R₂₀ are each independently selected from hydrogen or an alkyl group having 1, 2, 3, 4, 5, or 6 carbon atoms; d is 0 or 1; a is any integer between 0 and 100, with the proviso that when X is a moiety of the formula given in iii) above, b and c may each independently be any integer in the range of 0 to 390, and the sum of a+b+c is any number between 2 and 400. According to one preferred form of the invention, such secondary polyetheramines are diamines. According to another form of the invention, such secondary polyetheramines are triamines. Secondary polyetheramines of the present invention are not limited their functionality.

The secondary polyetheramines may comprise secondary polyoxyalkylene amines. The secondary polyoxyalkylene amines are commercially available from Huntsman Petrochemical Corporation of The Woodlands, Tex. under the designations XTJ-584, XTJ-585, XTJ-576 and XTJ-586. These chemicals have the general structure:

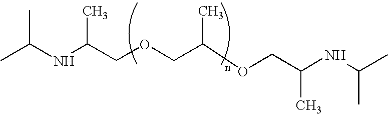

| | | |
|---|---|---|
| XTJ-584 (D-230): | n = ca. 1.7 | Avg MW˜314 |
| XTJ-585 (D-400): | n = ca. 5.1 | Avg MW˜512 |
| XTJ-576 (D-2000): | n = ca. 30.9 | Avg MW˜2007 |

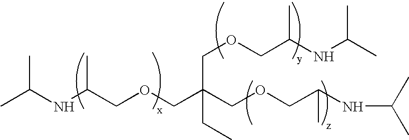

| | | |
|---|---|---|
| XTJ-586 (T-403): | x + y + z = ca. 5.3 | Avg MW˜567 |

One skilled in the art, with the benefit of this disclosure will recognize other appropriate secondary polyetheramines to use in embodiments of this invention.

Embodiments of the present invention include a second amine in the second component. The second amine may comprise primary polyetheramines such as JEFFAMINE® D-2000 amines and JEFFAMINE® T-5000 amines. In other embodiments, the second amine may comprise primary amine chain extenders such as 3-aminomethyl-3,5,5-trimethylcyclohexylamine (also known as IPDA or Isophorone Diamine), derivatives thereof and combinations thereof. In further embodiments, the second amine may comprise diethyl toluene diamine (also known as DETDA, CAS No. 68479-98-1, which is commercially available from the Albemarle Corporation of Baton Rouge, La. under the tradename ETHACURE® 100 curative), dimethylthio toluene diamine (also known as DMTDA, CAS No. 106264-79-3, which is commercially available from the Albemarle Corporation of Baton Rouge, La. under the tradename ETHACURE® 300 curative), derivatives thereof and combinations thereof. In other embodiments, the second amine may comprise secondary amine chain extenders (that are not secondary polyetheramines or aspartic esters) such as N,N′-dialkylamino-diphenylmethane (commercially available from Dorf Ketal Chemicals, LLC of Stafford, Tex. under the tradename UNILINK 4200® diamines), derivatives thereof and combinations thereof. In further embodiments, the second amine may comprise Bis(N-sec butylaminocyclohexyl)methane (commercially available from Dorf Ketal Chemicals, LLC of Stafford, Tex. under the tradename CLEARLINK® 1000 diamines), Bis(N-sec butyl 3-methyl aminocyclohexyl)methane (commercially available from Dorf Ketal Chemicals, LLC of Stafford, Tex. under the tradename CLEARLINK® 3000 diamines), derivatives thereof and combinations thereof. In another embodiment, the second amine may comprise N,N′-isopropyl (3-aminomethyl-3,5,5-trimethylcyclohexylamine) (commercially available from Huntsman Petrochemical Corporation under the tradename JEFFLINK® 754 diamines). In further embodiments, the second amine may comprises 1,3 bis Aminomethyl cyclohexane, and its secondary amine byproducts from alkylation with ketones; derivatives thereof and combinations thereof. UNILINK 4200® and CLEARLINK® are registered trademarks of Dorf Ketal Chemicals, LLC of Stafford, Tex. JEFFLINK® is a registered trademark of Huntsman Petrochemical Corporation of The Woodlands, Tex. ETHACURE® is a registered trademark of the Albemarle Corporation of Baton Rouge, La. One skilled in the art, with the benefit of this disclosure, will recognize other suitable second amines for use in the polymers and processes of the present invention.

The second component may also include a third amine that comprises at least one aspartic ester amine. These amines may comprise molecules with the following formula: 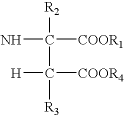
wherein R1 and R4 may be identical or different and represent an organic group, such as methyl or ethyl, and wherein R2 and R3 may be identical or different and represent an organic group or hydrogen. Aspartic ester amines are commerically available from Bayer MaterialScience LLC of Pittsburgh, Pa. under the tradename DESMOPHEN®.

In embodiments of the present invention, properties of the polymer can be adjusted through proper control of the ratio of secondary polyetheramines to second amines. Also the properties of the polymer can be adjusted through the addition of a third amine. How much of the secondary polyethermine is used depends on formulation considerations. Increasing the level of secondary polyetheramine may increase the flexibility of the polymer while not appreciably adjusting the overall cure time. In other embodiments of the present invention, the secondary polyetheramines may reduce the speed of the reaction during the production of polymers which enables formation of molded articles and coatings having higher structural integrity, especially in the end use of coatings, in which superior tear strengths heretofore unobserved in these coatings have been attained. Increased work time through the slower cure rate allows for smoother and glossier coatings to form, which are also aesthetically more appealing. Slower reaction rates allow for production of caulk and sealant formulations having sufficient gel time for practical use. Longer working times will also have benefit in adhesive and sealant applications where having more time to bring two surfaces into contact is critical to success. Also since polyetheramines may cost less than many second amines, production costs can be saved by using secondary polyetheramines as a substitute for the second amines. The secondary polyetheramines may also be used to modify the viscosity. In embodiments of the present invention, the ratio of the secondary polyetheramine parts to the second amine parts, not including any other parts of the compositions and wherein both parts equal 100, may range from about 0.1:99.9 to about 99.9:0.1. In other embodiments of the present invention, the ratio of the secondary polyetheramine to the second amine is from about 5:95 to about 75:25. In another embodiment, the ratio of the secondary polyetheramine to the second amine is from about 5:95 to about 50:50. Other embodiments allow ratios of 1:99 to 40:60, 1:99 to 30:70; 1:99 to 25:75; 1:99 to 20:80; and all ratios in between those previously listed. One skilled in the art, with the benefit of this disclosure will recognize an appropriate ratio of secondary polyetheramine to second amine in order to produce a polymer with a specific flexibility, viscosity, cure time, and cost.

In embodiments of the present invention, the first or second component, or both, may further comprise at least one polyol. Polyols may include, without limitation, polyether polyols, polyester polyols, polycarbonate polyols, other polyols, polyol chain extenders such as 1,4-butane diol catalyst. When a polyol is used, a hybrid polymer is formed such as a polyurea-polyurethane hybrid polymer. This invention teaches the use of secondary polyetheramines and aspartic ester amines in such hybrid polymers. One skilled in the art, with the benefit of this disclosure will recognize other suitable polyols for use in this invention.

In another embodiment of the present invention, additives may be used for the first or second component, or in both. The additives may include pigments; anti-oxidant additives; surface active additives; thixotropes; adhesion promoters; UV absorbers; derivatives thereof and combinations thereof. One skilled in the art, with the benefit of this disclosure, will recognize other suitable additives for use in the polymers and processes of the present invention.

In other embodiments of the present invention, a process is disclosed for the formation of a polymer. The process includes contacting the first component and the second component so as to form the polymer. To provide a polymer according to the present invention, a first component having isocyanate is mixed with a second component having secondary polyetheramine and second amine, either manually or automatically, using conventional production equipment. Typically, during the manufacturing process for producing polymers according to the prior art, the first and second components are normally kept separated from one another, such as by being contained in separate containers, until being mixed at the time of use. The second component is typically a blend of amines, pigments and other additives, and is sometimes referred to by those skilled in the art as the “resin blend”. The resin blend is usually prepared in advance of the mixing of the first component and the second component, and well mixed to ensure uniform dispersion of the pigments and amines, using mixing techniques which are known to those skilled in the art. The polymers can be formed by any number of ways known to those skilled in the art such as high-pressure impingement mix spraying, low pressure static-mix spray, low pressure static mix dispensing (caulk gun), hand techniques (including mixing by hand or hand tools and then applying the mixture manually with a brush, rollers, or other means), methods described in the background, and combinations thereof. One skilled in the art, with the benefit of this disclosure will recognize suitable methods of contacting the first and second components.

For many of the embodiments of the present invention, the ability to use the first and second components in polymer spray systems to form, without limitation, spray moldings or spray coatings, is a unique advantage over previous known isocyanate/amine systems. As the Examples will later demonstrate, using embodiments of the present invention allow isocyanate/amine components that traditionally set in 1 second, to be slowed to setting levels of up to 3 seconds. This allows isocyanate/amine systems that were previously unsuitable, or problematic, in polymer spray systems to be used in such applications. Such problems that would make the isocyanate/amine systems unsuitable for spray systems include gun problems, an unsmooth coating, or an inconsistent coating. For the purposes of this disclosure, a polymer spray system shall include any spray system capable of mixing two components to form a polymer, and shall include, but not be limited to, high-pressure impingement spray mixing equipment. One skilled in the art, with the benefit of this disclosure will recognize appropriate polymer spray systems that can be used in embodiments of the present invention.

In an embodiment of the present invention, a reduced viscosity amine mixture (resin blend) is disclosed. In another embodiment, a method is disclosed to reduce viscosity of an amine mixture (resin blend). The amine mixture, if using a second amine alone, may have an undesirable viscosity for many applications. By adding secondary polyetheramine to the second amine, the viscosity if the mixture may be adjusted to a desired level. One skilled in the art with the benefit of this disclosure will recognize appropriate amounts of secondary polyether amine to achieve amine mixtures with desired viscosities.

Polymers produced according to methods of the present invention are suitable for a wide range of end uses, including without limitation, the following: coatings for concrete, coatings over geotextile, spray on coatings, bridges, bridge pylons, bridge decks, water-proofing layers, tunnels, manholes, fish ponds, secondary containment, skid resistant layers, flooring, garages, aircraft hangars, sewer rehabilitation, water pipes, concrete pipes; coatings for metals, including masking layer for etching process, corrosion protection, ship hulls, ship decks, aircraft carrier decks, submarines, other military vehicles, helicopter rotor blades, bridges, structural members, playgrounds, automotive, truck-bed liners, under-carriage, outer body, rail-road cars and hoppers, trailers, flat bed trucks, 18 wheelers, large dirt moving equipment, rollers, aerospace, tank coatings (inside and out), pipe coating (inside and out); coatings for other substrates such as fiberglass boats, pavement marking, concrete marking, decorative/protective layer over various substrates for movie sets, amusement parks, parade floats, paint-ball props, electronics encapsulation, roofing topcoat for various substrates; coatings for polystyrene, wax, ice, or other media used in prototyping; manufacture of molded articles, such as reaction injection molded and products made using other molding techniques, prototype parts, shoe components, golf balls, decorative parts, automotive parts, bumpers, hubcaps; polyurea foam for sound insulation; thermal insulation; shock absorption; and other end use applications where polyurethane foam is known to be useful in the various arts; caulks for concrete floors and other architectural applications in which a sealant is employed, adhesives for bonding two components in a wide variety of substrates and applications where adhesives are normally employed; and sealants for a wide variety of non-architectural applications, such as on board of sea-going vessels. One skilled in the art, with the benefit of this application will recognize other appropriate uses for embodiments of this invention.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. The present disclosure includes the subject matter defined by any combination of any one of the various claims appended hereto with any one or more of the remaining claims, including the incorporation of the features and/or limitations of any dependent claim, singly or in combination with features and/or limitations of any one or more of the other dependent claims, with features and/or limitations of any one or more of the independent claims, with the remaining dependent claims in their original text being read and applied to any independent claim so modified. This also includes combination of the features and/or limitations of one or more of the independent claims with the features and/or limitations of another independent claim to arrive at a modified independent claim, with the remaining dependent claims in their original text being read and applied to any independent claim so modified. Accordingly, the presently disclosed invention is intended to cover all such modifications and alterations, and is limited only by the scope of the claims which follow, in view of the foregoing and other contents of this specification.

### EXPERIMENTAL

Techniques

Throughout this specification various test results are set forth, and the following test methods were employed in each occurrence of the following herein:

| Test | Method |
|---|---|
| Tensile strength | ASTM D-638 |
| Max Elongation | ASTM D-638 |
| Tear Strength | ASTM D-624 |
| String Gel | see below |
| Tack Free Time | see below |

The string gel and tack free time test methods are now described. The methods used depend upon the method of preparing the polymer polymers. For the spray method, a vertical surface is used as a target, which is typically a piece of cardboard or other disposable material. The spray gun is triggered to dispense polymer onto the cardboard at the same time as the stop watch is started. Spray is continued until sufficient material has built up to begin running downward. This is usually less than 2 seconds. “Gel Time” is the elapsed time from the start of the watch until the polymer material is no longer running down the vertical surface, i.e. the polymer has gelled to the point that it no longer flows under gravity. “Tack Free” is the time elapsed when the polymer surface is no longer sticky when touched by a gloved finger with light pressure.

Formulations 8349-6 and 8349-8 were created by static mix technique. All other data was from high pressure impingement mixing spray. For the preparation of samples using the high pressure impingement mixing spray method, a GUSMER® Marksman (or H20/35) proportioning unit (plural component) was used, fitted with a GUSMER® GX-7-400 spray gun. The equipment was set so as to process each example at a first to second component volume ratio of 1.00. Spray processing pressure was maintained at 1500 psi to 2500 psi on both the first and second components. Block heat, as well as hose heat, was set at 160° F.

For the static mix method, because static mix samples are normally dispensed into a horizontal mold, and therefore don't run, a different measurement is used and called “String gel” rather than just “Gel”. The stopwatch is started when the polymer is begun to be dispensed into the mold. The polymer surface in the area first coated is then touched lightly with a wooden tongue depressor and then lifted vertically. The test area must be from the first material because as many as 10-20 seconds can pass from the start to the end of dispensing of the polymer into the mold. In the early stages of cure, the polymer will stick to the depressor and rise up with the vertical motion pulling a “string” which eventually breaks loose. The touch and lift procedure is repeated until such time as the polymer surface no longer pulls vertically with the tongue depressor. The surface can still be tacky and soft at this point. “Tack Free” is the time elapsed at which point the polymer surface is no longer sticky when touched by a gloved finger with light pressure. Also, light pressure with a gloved finger should not create a “fingerprint” or depression in the surface. Even though the surface is “tack free” it may not be strong enough at this point to take a significant force without flowing or deforming.

In the tables which follow, the “A side” refers to the first component and the “B side” refers to the second component. Under the A side: DESMODUR® N-3400 polyisocyanate is an HDI trimer isocyanate available from Bayer MaterialScience, LLC of Pittsburgh, Pa., XTJ-576 is di-isopropyl substituted JEFFAMINE® D-2000 amine; and RUBINATE® 9480 MDI is an isocyanate; and SUPRASEC® 9549 MDI is an isocyanate commercially available from Huntsman International LLC of The Woodlands, Tex. Under the B side: JEFFAMINE® D-2000 amine is a primary amine, XTJ-584 is di-isopropyl substituted JEFFAMINE® D-230 diamine; product XTJ-585 is di-isopropyl substituted JEFFAMINE® D-400 diamine, DESMOPHEN® NH 1420 amine is an aspartic ester amine, JEFFLINK® 754 amine is a chain extender, TiO₂ is a pigment, JEFFAMINE® T-5000 amine is a primary amine with functionality between 2 and 3, ETHACURE® 100 curative is a diethyl toluene diamine, D230-CycC6 is a an experimental secondary polyetheramine based upon the alkylation of our JEFFAMINE® D-230 diamine with cyclohexanone, and T403-CycC6 is a trifunctional secondary polyetheramine based up JEFFAMINE® T-403 amine alkylated with cyclohexanone.

Comparisons

Attached are tables of some example data for using secondary polyetheramines in place of/with other chain extenders. Table 1 (Comparison Quartet) demonstrates replacing UNILINK 4200® diamines with XTJ-584, XTJ-586 or JEFFLINK® 754 amine. Table 2 (Comparison Pair (8391-28 and 8314-9)) demonstrates partially replacing UNILINK 4200® diamines with XTJ-585. Table 3 shows aliphatic formulations using secondary polyetheramines to increase gel time. Table 4 (Comparison Pair (8349-93 and 8391-42)) demonstrates the speed reduction for the partial replacement of JEFFLINK® 754 amine with XTJ-585.

Comparison Quartet

Table 1 demonstrates replacing UNILINK 4200® diamines with XTJ-584, XTJ-586 or JEFFLINK® 754 amine. Sample 8276-72 is the control sample having 10% UNILINK 4200® diamines. Sample 8314-12 replaces the UNILINK 4200® diamines with 8% JL754, Sample 8276-93 replaces the UNILINK 4200® diamines with 15% XTJ-586 and Sample 8276-92 replaces the UNILINK 4200® diamines with 10% XTJ-584. A comparison of these Samples show that the gel time and tack free time are essentially unchanged at 6 seconds (sec) and 11 sec respectively. Coatings properties are essentially the same between the Samples except for the XTJ-586 Sample (8276-93), which most likely increases crosslinking with the expected drop in elongation.

Comparison Pair (8391-28 and 8314-9)

Table 2 demonstrates partially replacing UNILINK 4200® diamines with XTJ-585. Sample 8391-28 has 35% UNILINK 4200® diamines, 33% JEFFAMINE® D-2000 amine and no XTJ-585. Sample 8314-9 has 27% UNILINK 4200® diamines, 23% JEFFAMINE® D-2000 amine and 18% XTJ-585. By replacing some of the UNILINK 4200® diamines with XTJ-585, the elongation was improved from 178% to 231% while maintaining a cure speed of 6 sec. This kind of substitution may help to ensure that the coating remains flexible at high NCO levels.

Comparison Trio

Table 3 shows aliphatic formulations using secondary polyetheramines to increase gel time. In these Samples faster curing JEFFLINK® 754 amine and JEFFAMINE® D-400 diamine were replaced with slower curing polyetheramines. Sample 8276-68 has 20% JEFFAMINE® D-400 diamine and 60% JEFFLINK® 754 amine. Sample 8276-71 has replaced the JEFFAMINE® D-400 diamine with 25% XTJ-585 with a resulting decrease in cure time from 1 to 2 seconds. Sample 8349-31 further improves the elongation to 96% from 15% and further reduces cure speed by replacing JEFFLINK® 754 amine with the secondary PEA with 4-methyl 2-pentyl groups on Jeffamine T-403. The improvement from 1 sec to 3 sec is significant in polymer spray systems and may result in less gun problems, smoother coatings and more consistent coatings.

Comparison Pair (8349-93 and 8391-42)

Table 4 demonstrates the speed reduction in cure time for the partial replacement of JEFFLINK® 754 amine with XTJ-585. Sample 8349-93 has 45% JEFFAMINE® D-2000 amine, 50% JEFFLINK® 754 amine and no XTJ-585. Sample 8391-42 has 30% JEFFAMINE® D-2000 amine, 45% JEFFLINK® 754 amine and 20% XTJ-585. A comparison shows a speed reduction from 2.75 sec to 5.5 sec. This is a significant reduction in cure speed. The XTJ-585 Sample also shows an increase in the % elongation. The ultimate tensile strength of the XTJ-585 Sample is even improved over the base case formulation.

TABLE 1

| | Sample No. | | | |
|---|---|---|---|---|
| | 8276-72 | 8314-12 | 8276-93 | 8276-92 |
| A Side | | | | |
| RUBINATE ® 9480 | 100 | 100 | 100 | 100 |
| MDI | | | | |
| % NCO | 15.2 | 15.2 | 15.2 | 15.2 |
| B Side | | | | |
| JEFFAMINE ® D-2000 | 53 | 55 | 48 | 53 |
| amine | | | | |
| JEFFAMINE T-5000 | 10 | 10 | 10 | 10 |
| amine | | | | |
| ETHACURE ® 100 | 22 | 22 | 22 | 22 |
| XTJ-584 | 0 | 0 | 0 | 10 |
| XTJ-586 | 0 | 0 | 15 | 0 |
| JEFFLINK ® 754 amine | 0 | 8 | 0 | 0 |
| UNILINK 4200 ® | 10 | 0 | 0 | 0 |
| diamines | | | | |
| TiO2 | 5 | 5 | 5 | 5 |
| Volume Ratio | 1 | 1 | 1 | 1 |
| Wt Ratio (iso/resin) | 1.101 | 1.111 | 1.111 | 1.111 |
| Index (NCO/N) | 1.096 | 1.105 | 1.086 | 1.115 |
| Tensile Strength, psi | 2902 | 2664 | 2642 | 2569 |
| Max Elongation, % | 637 | 606 | 492 | 653 |
| 100% Modulus, psi | 1116 | 1064 | 1168 | 1007 |
| 300% Modulus, psi | 1639 | 1569 | 1767 | 1454 |
| Youngs Modulus, psi | 10514 | 11626 | 12456 | 10117 |
| Tear Strength, pli | 506 | 476 | 423 | 478 |
| Shore D, 0 sec/10 sec | 50/41 | 51/43 | 53/44 | 52/41 |
| Spray, Gel Time, sec | 6 | 7 | 6 | 7 |
| Tack Free, sec | 12 | 11 | 10 | 11.5 |

TABLE 2

Reference No.

| | 8391-28 | 8314-9 |
|---|---|---|
| A Side | | |
| SUPRASEC ® 9549 MDI | 100 | 100 |
| % NCO | 19.4 | 19.4 |
| JEFFAMINE ® D-2000 amine | 33 | 23 |
| JEFFAMINE ® T-5000 amine | 9 | 9 |
| ETHACURE ® 100 curative | 18 | 18 |
| XTJ-584 | 0 | 0 |
| XTJ-585 | 0 | 18 |
| XTJ-586 | 0 | 0 |
| UNILINK 4200 ® diamines | 35 | 27 |
| TiO2 | 5 | 5 |
| Volume Ratio | 1 | 1 |
| Wt Ratio (iso/resin) | 1.121 | 1.136 |
| Index (NCO/N) | 1.113 | 1.116 |
| Tensile Strength, psi | 2501 | 2477 |
| Max Elongation, % | 178 | 231 |
| 100% Modulus, psi | 2145 | 1984 |
| 300% Modulus, psi | N/A | N/A |
| Youngs Modulus, psi | 33203 | 30452 |
| Tear Strength, pli | 621 | 605 |
| Shore D, 0 sec/10 sec | 68/61 | 61/54 |
| Spray, Gel Time, sec | 6 | 6 |
| Tack Free, sec | 10 | 16 |

TABLE 3

| | Sample No. | | |
|---|---|---|---|
| | 8276-68 | 8276-71 | 8349-31 |
| A Side | | | |
| H12MDI | 0 | 0 | 0 |
| DESMODUR ® N-3400 | 100 | 100 | 100 |
| polyisocyanate | | | |
| XTJ-576 | 0 | 0 | 0 |
| % NCO | 21.76 | 21.76 | 21.76 |
| B Side | | | |
| JEFFAMINE ® D-2000 amine | 15 | 10 | 10 |
| XTJ-584 | 0 | 0 | 10 |
| JEFFAMINE ® D-400 diamine | 20 | 0 | 0 |
| XTJ-585 | 0 | 25 | 0 |
| T-403-MIBK | 0 | 0 | 30 |
| JEFFLINK ® 754 amine | 60 | 65 | 45 |
| TiO2 | 5 | 0 | 5 |
| Volume Ratio | 1 | 1 | 1 |
| Wt Ratio (iso/resin) | 1.208 | 1.287 | 1.209 |
| Index (NCO/N) | 1.065 | 1.086 | 1.146 |
| Tensile Strength, psi | 5282 | 5166 | 3401 |
| Max Elongation, % | 14 | 13 | 96 |
| 100% Modulus, psi | N/A | N/A | 2360 |
| 300% Modulus, psi | N/A | N/A | N/A |
| Youngs Modulus, psi | 58640 | 69162 | 46020 |
| Tear Strength, pli | 354 | 692 | 748 |
| Shore D, 0 sec/10 sec | 73/69 | 78/73 | 73/64 |
| Spray, Gel Time, sec | 1 | 2 | 3 |
| Tack Free, sec | 5 | 9 | 15 |

TABLE 4

| | Sample No. | |
|---|---|---|
| | 8349-93 | 8391-42 |
| A Side | | |
| H12MDI | 0 | 0 |
| DESMODUR ® N-3400 polyisocyanate | 85 | 85 |
| XTJ-576 | 15 | 15 |
| % NCO | 17.03 | 17.77 |
| B Side | | |
| JEFFAMINE ® D-2000 amine | 45 | 30 |
| XTJ-584 | 0 | 0 |
| JEFFAMINE ® D-400 diamine | 0 | 0 |
| XTJ-585 | 0 | 20 |
| T-403-MIBK | 0 | 0 |
| JEFFLINK ® 754 amine | 50 | 45 |
| TiO2 | 5 | 5 |
| Volume Ratio | 1 | 1 |
| Wt Ratio (iso/resin) | 1.144 | 1.167 |
| Index (NCO/N) | 1.086 | 1.088 |
| Tensile Strength, psi | 1564 | 1939 |
| Max Elongation, % | 280 | 401 |
| 100% Modulus, psi | 852 | 593 |
| 300% Modulus, psi | N/A | 1323 |
| Youngs Modulus, psi | 6482 | 2540 |
| Tear Strength, pli | 261 | 212 |
| Shore D, 0 sec/10 sec | 43/26 | 52/26 |
| Spray, Gel Time, sec | 2.75 | 5.5 |
| Tack Free, sec | 9.75 | 27 |

What is claimed is:

1) A process for producting a polymer comprising:
providing a first component having at least one isocyanate;
providing a second component having at least one secondary polyetheramine and at least one second amine; and
contacting the first component and the second component so as to form the polymer.

2) A process according to claim 1 wherein the at least one second amine comprises N,N′-dialkylamino-diphenylmethane, derivatives thereof or combinations thereof.

3) A process according to claim 1 wherein the at least one second amine comprises Bis(N-sec butylaminocyclohexyl)methane, Bis(N-sec butyl 3-methyl aminocyclohexyl)methane, derivatives thereof or combinations thereof.

4) A process according to claim 1 wherein the at least one second amine comprises N,N′-isopropyl (3-aminomethyl-3,5,5-trimethylcyclohexylamine), derivatives thereof or combinations thereof.

5) A process according to claim 1 wherein the at least one second amine comprises 3-aminomethyl-3,5,5-trimethylcyclohexylamine, derivatives thereof or combinations thereof.

6) A process according to claim 1 wherein the at least one second amine comprises diethyl toluene diamine, dimethylthio toluene diamine, derivatives thereof or combinations thereof.

7) A process according to claim 1 wherein the at least one second amine comprises 1,3 bis Aminomethyl cyclohexane, secondary amine byproducts from alkylation of 1,3 bis Aminomethyl cyclohexane, derivatives thereof and combinations thereof.

8) A process according to claim 1 wherein the second component further comprises a third amine comprising at least one aspartic ester amine.

9) A process of claim 1 wherein the first component, second component, or both the first component and second component further comprise at least one polyol.

10) A process of claim 9 wherein the polyol is selected from the group consisting of: a polyether polyol, a polyester polyol, a polycarbonate polyol, and a polyol chain extender.

11) A process according to claim 1 wherein the second polyetheramine comprises a secondary monoamine.

12) A process according to claim 1 wherein the second polyetheramine comprises a secondary diamine.

13) A process according to claim 1 wherein the secondary polyetheramine comprises a secondary polyoxyalkylene amine.

14) A process according to claim 1 wherein the second polyetheramine comprises a secondary triamine.

15) A process according to claim 1 wherein contacting the first component and the second component so as to form the polymer comprises using a polymer spray system.

16) A polymer produced by:
providing a first component having at least one isocyanate;
providing a second component having at least one secondary polyetheramine and at least one second amine; and
contacting the first component and the second component so as to form the polymer.

17) A polymer according to claim 16 wherein the secondary polyetheramine is selected from the group consisting of: a secondary monoamine, a monoamine, derivatives thereof and combinations thereof.

18) A polymer of claim 16 wherein the first component, second component, or both the first component and second component further comprise at least one polyol.

19) A polymer according to claim 16 wherein contacting the first component and the second component so as to form the polymer comprises using a polymer spray system.

20) A polymer produced by:
providing a first component having at least one isocyanate;
providing a second component having at least one secondary polyetheramine and at least one second amine; and
contacting the first component and the second component so as to form the polymer using a polymer spray system.
